(19) United States
(12) Patent Application Publication
(10) Pub. No.: US 2020/0084345 A1
(43) Pub. Date: Mar. 12, 2020

(54) CAMERA ENCLOSURE DEVICE

(71) Applicant: Surveillance Technology Solutions, LLC, Mims, FL (US)

(72) Inventors: Thomas P. Calnan, Mims, FL (US); Patrick D. Calnan, Mims, FL (US)

(73) Assignee: Surveillance Technology Solutions, LLC, Mims, FL (US)

(21) Appl. No.: 16/418,252

(22) Filed: May 21, 2019

Related U.S. Application Data
(60) Provisional application No. 62/728,354, filed on Sep. 7, 2018.

(51) Int. Cl. H04N 5/225; G03B 17/08

(52) U.S. Cl. CPC H04N 5/2252; G03B 17/08; H04N 5/2254

(57) ABSTRACT

A camera enclosure device forming a waterproof covert camera enclosure for a security camera may include a front cover having a curved front plate, and the curved front plate may be coupled between a left side plate and a right side plate. A top plate may be coupled to an upper end of the front cover, and the top plate may extend to contact the curved front plate, the left side plate, and the right side plate. A lens aperture may be disposed in the front cover. A rear panel may be coupled to the front cover, and the rear panel may be coupled to a bottom plate which may extend to contact the curved front plate, the left side plate, and the right side plate at a lower end of the front cover when the rear panel is coupled to the front cover.

### CROSS REFERENCE TO RELATED APPLICATIONS

This application claims priority to and the benefit of the filing date of U.S. Provisional Application No. 62/728,354, filed on Sep. 7, 2018, entitled “WATERPROOF COVERT CAMERA ENCLOSURE”, which is hereby incorporated by reference in its entirety.

### FIELD OF THE INVENTION

This patent specification relates to the field of security devices. More specifically, this patent specification relates to a waterproof covert camera enclosure and unobstructed field of view.

### BACKGROUND

Covert camera enclosures are typically square or rectangular boxes limiting the continuous field of view of the camera lens. Others have enlarged the window opening to try and get a wider field of view but there are still limitations in the field of view at the corners of the box, and the covert appearance of the enclosure is questionable. Therefore, a need exists for a novel waterproof covert camera enclosure with a wider field of view.

### BRIEF SUMMARY OF THE INVENTION

A camera enclosure device is provided which may be configured as a waterproof covert camera enclosure for one or more security cameras. In some embodiments, the device may include a front cover having a curved front plate, and the curved front plate may be coupled between a left side plate and a right side plate. A top plate may be coupled to an upper end of the front cover, and the top plate may extend to contact the curved front plate, the left side plate, and the right side plate. A lens aperture may be disposed in the front cover. A rear panel may be coupled to the front cover, and the rear panel may be coupled to a bottom plate which may extend to contact the curved front plate, the left side plate, and the right side plate at a lower end of the front cover when the rear panel is coupled to the front cover. Preferably, the front cover, rear panel, top plate, and bottom plate may be coupled together to form a waterproof covert camera enclosure for a security camera. The lens aperture may be configured to provide an approximately 220 degree field of view for a security camera that is mounted within the device.

In further embodiments, the lens aperture may extend from the left side plate to the right side plate.

In still further embodiments, a lens may be coupled to the lens aperture, and the lens may be coupled to the curved front plate, the left side plate, and the right side plate.

In further embodiments, the device may form a weatherproof housing for a security camera and associated security equipment. The weatherproof covert enclosure of the device provides 220 degrees of continuous viewing with no structural enclosure framework to block the camera lens from continuous viewing. The preferably continuous one-piece optically correct narrow camera lens opening provides a covert appearance with an unencumbered 220-degree field of view. The covert enclosure is capable of mounting to flat walls or any type of round, square or concrete style poles with interchangeable mounts for these surfaces. The top of the enclosure provides mounting for an antenna or antenna system. As a non-limiting example, the antenna may be a high gain 4G/5G cellular antenna and ground plane.

Numerous objects, features and advantages of the present invention will be readily apparent to those of ordinary skill in the art upon a reading of the following detailed description

An object of the invention is to provide a weatherproof enclosure for a security camera and associated security equipment.

Another object of the invention is to provide an unobstructed 220-degree field of view for the security camera.

A further object of the invention is to provide interchangeable mounting options for mounting the enclosure on a flat wall or on a pole.

Yet another object of the invention is to provide a non-traditional appearance for the enclosure.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a camera enclosure device according to various embodiments described herein.

FIG. 2 illustrates a perspective view of an example of a front cover and top plate of a camera enclosure device according to various embodiments described herein.

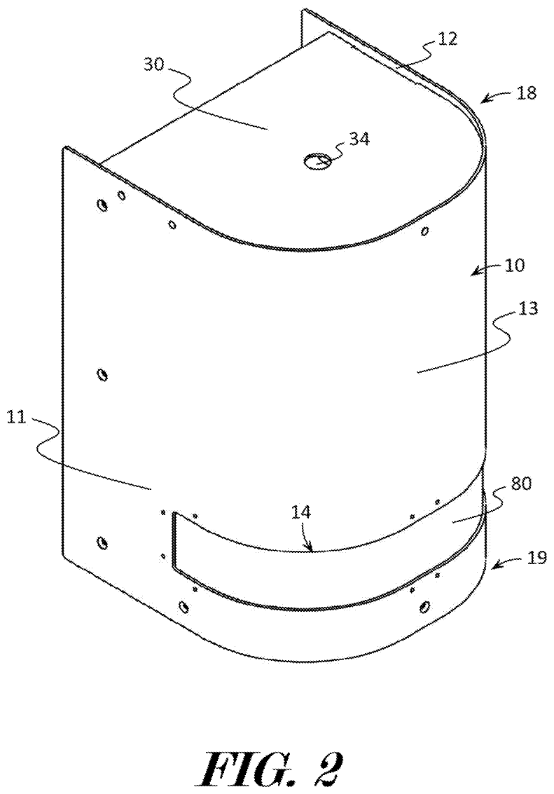

FIG. 3 shows a rear perspective view of an example of a rear panel and bottom plate and wall bracket of a camera enclosure device according to various embodiments described herein.

FIG. 4 depicts a front perspective view of an example of a rear panel and bottom plate of a camera enclosure device with a pole mount according to various embodiments described herein.

FIG. 5 illustrates a perspective view of an example of a wall bracket according to various embodiments described herein.

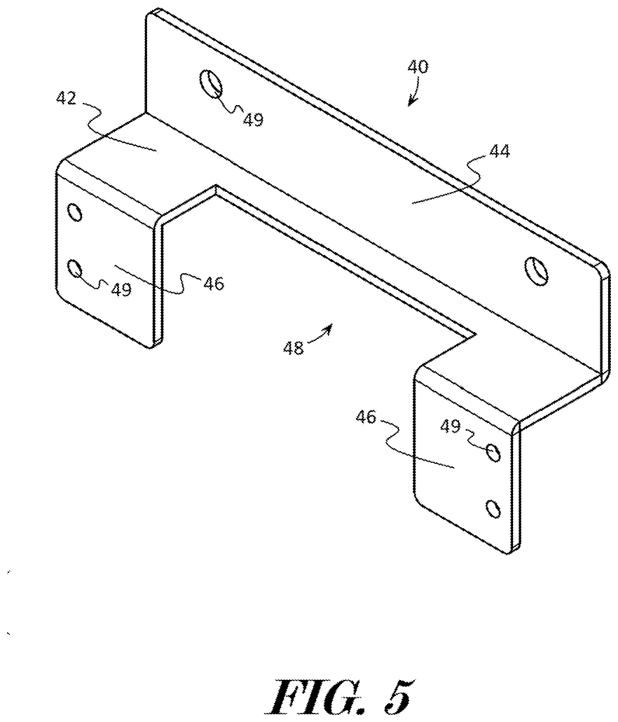

FIG. 6 shows a perspective view of an example of a pole mount according to various embodiments described herein.

FIG. 7 depicts a perspective view of an example of a lens and lens retainer of a camera enclosure device according to various embodiments described herein.

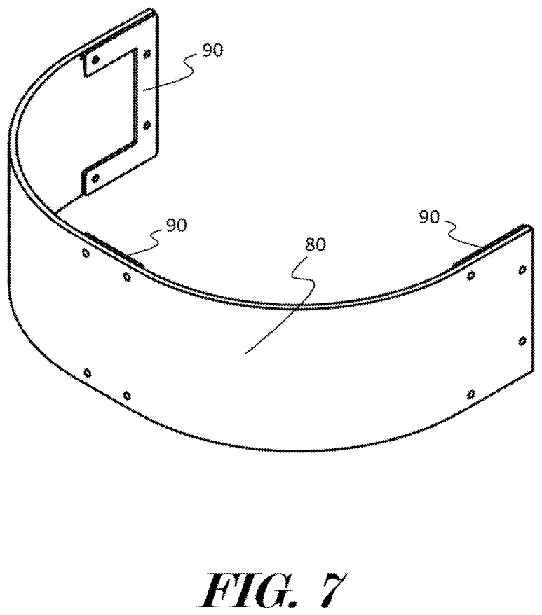

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the word “or” is intended to be inclusive.

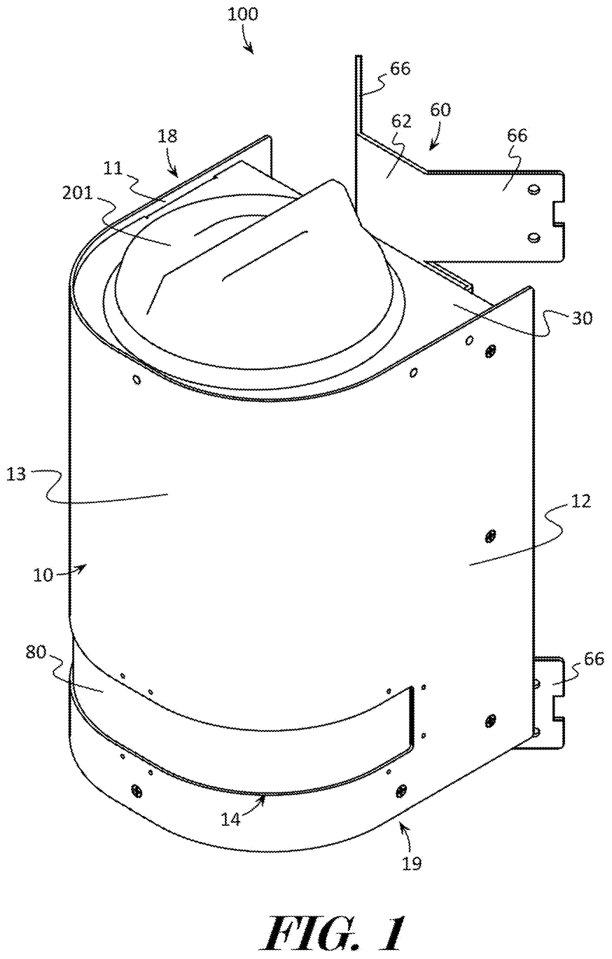

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” refers to top and “lower” refers to the bottom. As a non-limiting example, the upper end of a vertical shaft is the top end of the vertical shaft.

As used herein, “align” refers to the placement of two or more components into positions and orientations which either arranges the components along a straight line or within the same plane or which will allow the next step of assembly to proceed. As a non-limiting example, the next step of assembly may be to insert one component into another component, requiring alignment of the components.

As used in this disclosure, an “aperture” is an opening in a surface. Aperture may be synonymous with hole, slit, crack, gap, slot, or opening.

As used in this disclosure, “bendable” refers to an object or material which will deform when a force is applied to it, which will not return to its original shape when the deforming force is removed, and which will retain the deformed shape caused by the deforming force.

As used in this disclosure, a “cable” is one or more, such as a collection of, insulated wires covered by a protective casing that is used for transmitting electricity or telecommunication signals.

As used in this disclosure, a “camera” is a device having a sensor that converts light into electric signals that encode the spatial orientation of the captured light in a manner that reproduces the images seen by a human eye.

As used herein, the words “couple”, “couples”, “coupled” or “coupling”, refer to connecting, either directly or indirectly, and does not necessarily imply a mechanical connection.

As used here, “footprint” refers to a vertical, downward projection of an object onto the surface that supports the object. The portion of the supporting surface that is within the footprint is, by definition, underneath the object.

As used herein, “front” indicates the side of an object that is closest to a forward direction of travel under normal use of the object or the side or part of an object that normally presents itself to view or that is normally used first. “Rear” or “back’ refers to the side that is opposite the front.

As used in this disclosure, “horizontal” is a directional term that refers to a direction that is perpendicular to the local force of gravity. Unless specifically noted in this disclosure, the horizontal direction is always perpendicular to the vertical direction.

As used in this disclosure, a “housing” is a rigid casing that encloses and protects one or more devices.

As used in this disclosure, the word “lateral” refers to the sides of an object or movement towards a side. Lateral directions are generally perpendicular to longitudinal directions. “Laterally” refers to movement in a lateral direction.

As used in this disclosure, a “lens” is a transparent substance through which light can pass. A lens may or may not be formed with curved surfaces that are used to concentrate or disperse the light that travels through the lens.

As used herein, “oblique angle” refers to any angle that is not a right angle or a multiple of a right angle.

As used herein, the words “painted” or “tinted” refer to a change of coloration produced using paint, ink, dyes, powder coating, shrink wrap, or other coloring agents. The method of producing such a coloration change may include pens, brushes, stamps, stencils, electrostatically charged, or other methods of applying a coloring agent.

As used in this disclosure, a “plate” is a flat, rigid object having at least one dimension that is of uniform thickness and is thinner than the other dimensions of the object. Plates often have a rectangular or disk like appearance. Plates may be made of any material, but are commonly made of metal.

As used in this disclosure, “transparent” refers to a material that allows light to pass through the material without significant scattering such that an object can be clearly seen through the material.

As used in this disclosure, “vertical” refers to a direction that is parallel to the local force of gravity. Unless specifically noted in this disclosure, the vertical direction is always perpendicular to horizontal.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new waterproof covert camera enclosure is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIG. 1 illustrates an example of a camera enclosure device (“the device”) 100 according to various embodiments. In some embodiments, the device 100 may comprise a front cover 10 having a curved front plate 13, and the curved front plate 13 may be coupled between a left side plate 11 and a right side plate 12. A top plate 30 may be coupled to an upper end 18 of the front cover 10, and the top plate 30 may extend to contact the curved front plate 13, the left side plate 11, and the right side plate 12. A lens aperture 14 may be disposed in the front cover 10. A rear panel 20 may be coupled to the front cover 10. The rear panel 20 may be coupled to a bottom plate 25 which may extend to contact the curved front plate 13, the left side plate 11, and the right side plate 12 at a lower end 19 of the front cover 10 when the rear panel 20 is coupled to the front cover 10. Preferably, the front cover 10, rear panel 20, top plate 30, and bottom plate 25 may be coupled together to form a waterproof covert camera enclosure for a security camera. The lens aperture 14 may be configured to provide an approximately 220 degree field of view for a security camera that is mounted within the device 100.

In some embodiments, the front cover 10 may comprise a left side plate 11, a right side plate 12, and a curved front plate 13. In preferred embodiments, the left side plate 11, right side plate 12, and curved front plate 13 may be coupled together by being integrally formed together, such as by being fabricated from a single piece of material that is cut, stamped, or otherwise shaped or bent to form the front cover 10, although other coupling method may be used. In further preferred embodiments, the plates 11, 12, 13, of the front cover 10 may be one piece of bent or curved metal which may be formed by a process of bending that typically requires a computerized machine that bends the metal in STEPS (called Step bending). In further embodiments, the plates 11, 12, 13, of the front cover 10 may be one piece of bent or curved metal which may be formed using a Form Mold, extrusion mold, or any other molding process.

The front cover 10 may comprise any size and shape. In some embodiments, the curved front plate 13 may comprise a generally curved planar shape and all or portions of the left side plate 11 and/or right side plate 12 may optionally be generally planar or curved planar in shape so that the curved front plate 13 and optionally all or portions of the left side plate 11 and/or right side plate 12 may generally resemble a section of an upright cylinder. In other embodiments, the left side plate 11 and the right side plate 12 may be generally planar in shape and optionally parallel to each other.

The front cover 10 may comprise one or more lens apertures 14. All or portions of a lens aperture 14 may be disposed in the left side plate 11, right side plate 12, and/or curved front plate 13. A lens aperture 14 may be configured in any size and shape. In some embodiments, a lens aperture 14 may be configured with a generally rectangular shape that may be curved to match the contours of the portions of the left side plate 11, right side plate 12, and/or curved front plate 13 that the lens aperture 14 may be disposed in.

In preferred embodiments, a lens aperture 14 may extend across the curved front plate 13 and into portions of the left side plate 11 and right side plate 12 to form a window having a field of view of approximately 220 degrees for a camera that may be positioned behind the front cover 10. In other embodiments, a lens aperture 14 may extend across the curved front plate 13 and optionally into portions of the left side plate 11 and right side plate 12 to form a window having a field of view of between 90 and 300 degrees for a camera that may be positioned behind the front cover 10.

Generally, a rear panel 20 may comprise a back cover for the device 100. Preferably, the rear panel 20 may be removably coupled to the front cover 10 or other element of the device 100 so that the rear panel 20 may be removed. The rear panel 20 may be configured in any size and shape, while in preferred embodiments, the rear panel 20 may be configured with a planar rectangular shape. The rear panel 20 may comprise one or more rear apertures 22 of any size and shape which may be used to allow cables to pass through the rear panel 20 and one or more fasteners to engage with the rear panel 20. As non-limiting examples, the cables may be power and/or video cables for a security camera and other electronic devices. In some embodiments, the device 100 may comprise a cable inlet 21 which may be configured to enable a cable, such as a power cable, to pass through the rear panel 20, such as via a rear aperture 22 to connect with a main power supply 28. One or more electrical elements housed in the device 100, such as a camera, communication equipment, a circulation fan 71, etc., may be in electrical communication with the main power supply 28 to be provided with electrical power.

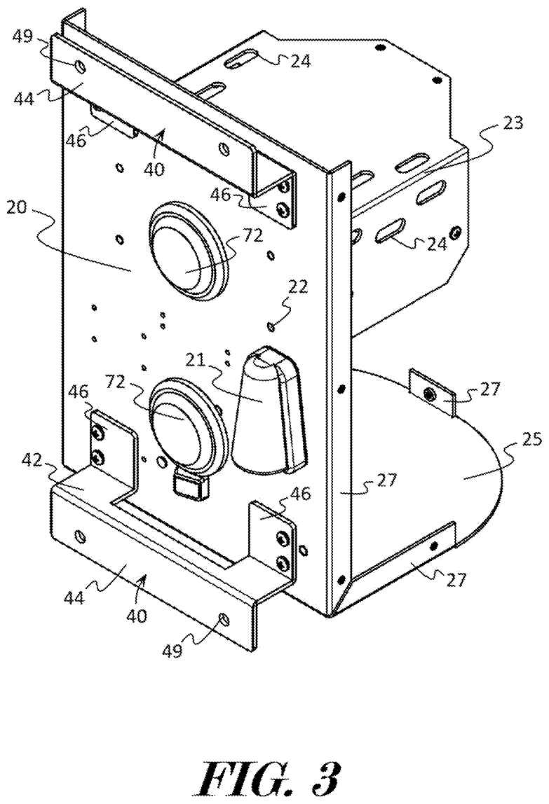

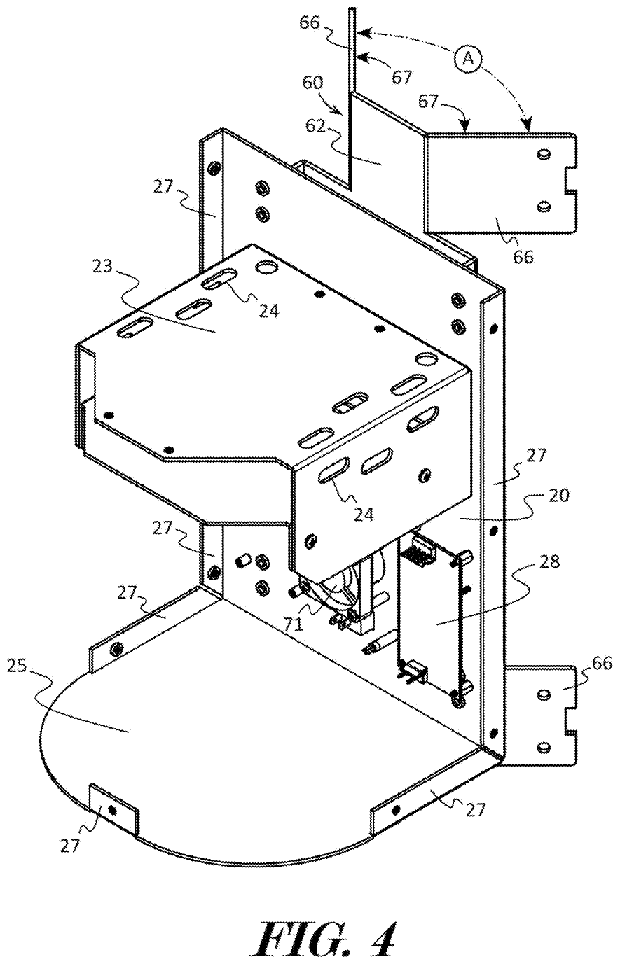

In preferred embodiments, the device 100 may comprise one or more mounting plates 23 to which one or more electronic or other elements of the device 100 may be coupled to. A mounting plate 23 may be configured in any size and shape. Furthermore, a mounting plate 23 may comprise one or more mounting apertures 24 of any size and shape which may be used to allow cables to pass through the mounting plate 23 and/or one or more fasteners to engage with the mounting plate 23. In further embodiments, a mounting plate 23 may be coupled to the rear panel 20 as perhaps best shown in FIGS. 3 and 4.

In some embodiments, the rear panel 20 may be coupled to the bottom plate 25 so that the rear panel 20 may be integrally formed with the bottom plate 25, although any other coupling method may be used. For example, the bottom plate 25 may be a forward extension of the rear panel 20 that is generally perpendicular to the bottom of the rear panel 20. In preferred embodiments, the bottom plate 25 may conform to the footprint of the front cover 10 so that the bottom plate 25 may extend to contact the curved front plate 13, the left side plate 11, and the right side plate 12 at a lower end 19 of the front cover 10 when the rear panel 20 and/or bottom plate 25 is coupled to the front cover 10. In further preferred embodiments, the lateral sides of the bottom plate 25 may be parallel to each other and the front edge of the bottom plate 25 may be curved to align with the curvature of the curved front plate 13.

In some embodiments, the rear panel 20 and/or the bottom plate 25 may comprise one or more flanges 27 to aid in the coupling of the rear panel 20 and/or the bottom plate 25 to the front cover 10. A flange 27 may comprise an extension of material which may extend away from a rear panel 20 and/or the bottom plate 25, and the flange 27 may accept a fastener or other coupling method which may be used to couple the flange 27 and therefore the rear panel 20 and/or bottom plate 25 to the front cover 10.

In some embodiments, a rear panel 20, bottom plate 25, top plate 30, front cover 10, and/or one or more flanges 27 may be fabricated from a single piece of material that may be cut, stamped, or otherwise shaped and then bent to form the rear panel 20, bottom plate 25, top plate 30, front cover 10, and/or one or more flanges 27. In other embodiments, a rear panel 20, bottom plate 25, top plate 30, front cover 10, and/or one or more flanges 27 may be coupled with any other suitable coupling method.

The top plate 30 may generally be configured as a top cover for the device 100. In some embodiments, the top plate 30 may be removably coupled to the front cover 10 and/or the rear panel 20. In preferred embodiments, the top plate 30 may conform to the footprint of the front cover 10 so that the top plate 30 may extend to contact the curved front plate 13, the left side plate 11, and the right side plate 12. In further embodiments, the lateral sides of the top plate 30 may be parallel to each other and the front edge of the top plate 30 may be curved to align with the curvature of the curved front plate 13. Preferably, the rear side of the top plate 30 may be a straight edge that may be perpendicular to the lateral sides.

In some embodiments, the top plate 30 may comprise one or more cable apertures 34. A cable aperture 34 may be configured in any size and shape. Preferably, a top cable aperture 34 may provide a path for an antenna cable to run from equipment within the device 100 to an antenna 201 or antenna system that may be mounted on top of the top plate 30 as perhaps best shown in FIG. 1.

In some embodiments, the top plate 30 may comprise one or more flanges 27 which may be configured to aid in the coupling of the rear panel 20 and/or front cover 10 to the top plate 30.

In some embodiments, a top plate 30 and one or more flanges 27 may be fabricated from a single piece of material that may be cut, stamped, or otherwise shaped and then bent to form the top plate 30 and the one or more flanges 27.

In some embodiments, one or more elements of the device 100, such as a front cover 10, rear panel 20, top plate 30, and/or a bottom plate 25 may be made from or may comprise one or more rigid or bendable materials. As non-limiting examples, a front cover 10, rear panel 20, top plate 30, and/or a bottom plate 25 may comprise plastic, aluminum, stainless steel, and other metals and metal alloys. In further embodiments, one or more elements of the device 100, such as a front cover 10, rear panel 20, top plate 30, and/or a bottom plate 25 may be made from or may comprise ceramics, such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, wood, other plant based materials, or any other material including combinations of materials that are substantially rigid.

In some embodiments, one or more elements of the device 100, such as a front cover 10, rear panel 20, top plate 30, and/or a bottom plate 25 may be finished for appearance. As non-limiting examples, a front cover 10, rear panel 20, top plate 30, and/or a bottom plate 25 may be painted, powder coated, anodized, brushed, rubberized, or otherwise finished.

The device 100 may comprise one or more lenses 80. In preferred embodiments, a lens 80 may be coupled to a lens aperture 14 so that the lens 80 may fill or seal the lens aperture 14. In preferred embodiments, a lens 80 may be coupled to a lens aperture 14 that may extend across the curved front plate 13 and into portions of the left side plate 11 and right side plate 12 so that the lens 80 may provide a field of view of approximately 220 degrees for a camera that may be positioned behind the front cover 10. In further preferred embodiments, a lens 80 may be coupled to a lens aperture 14 that may extend across the curved front plate 13 and into portions of the left side plate 11 and right side plate 12 so that the lens 80 may be coupled to the curved front plate 13, the left side plate 11, and the right side plate 12. In other embodiments, a lens 80 may be coupled to a lens aperture 14 that may extend across the curved front plate 13 and optionally into portions of the left side plate 11 and right side plate 12 so that the lens 80 may provide a field of view of between 90 and 300 degrees for a camera that may be positioned behind the front cover 10. In further embodiments, a lens 80 may be coupled to a lens aperture 14 that may extend across the curved front plate 13 and optionally into portions of the left side plate 11 and right side plate 12 so that the lens 80 may be coupled to the curved front plate 13 and optionally to the left side plate 11, and/or the right side plate 12.

In preferred embodiments, a lens 80 may be made from or comprise durable and rigid materials which may be substantially transparent or translucent. Example durable and rigid materials which may be substantially transparent or translucent include plastics such as polycarbonate, acrylic or polyacrylate made from Methyl Methacrylate (MMA), Poly Methyl Methacrylate, or a combination of both, polystyrene, and glass. In further embodiments, a lens 20 may be a transparent, semi-transparent, one-way transparent, mirrored, and/or a smoked plastic window that fits into a lens aperture 14 of the front cover 10. Preferably, a lens 80 may conform to or substantially match the shape of a lens aperture 14. In further preferred embodiments, a lens 80 may be fabricated from optically correct glass, plastic, or other material.

In some embodiments, a lens 80 may be coupled within a lens aperture 14 via one or more fasteners, adhesives, or another fastening system. In further embodiments, a lens 80 may comprise a lens retainer 90 which may comprise one or more materials which may be coupled to the lens 80 and used to structurally reinforce the lens 80 for coupling within the lens aperture 14. It should be understood to one of ordinary skill in the art that a lens retainer 90 may be mounted in a vertical orientation (as shown), rotated 90 degrees to be mounted in a horizontal orientation, or mounted in any other orientation.

In some embodiments, the device 100 may comprise one or more circulation fans 71 which may be configured to circulate air within and/or in and out of the device 100. Generally, a circulation fan 71 may comprise a machine used to create flow within a fluid, such as air. Preferably, a fan circulation fan 71 may comprise a rotating arrangement of vanes or blades which may act on air within the device 100 to cause or direct the airflow. Example circulation fans 71 include axial-flow fans, centrifugal fans, cross-flow fans, bellows, Coand\check{a} effect air movers, electrostatic air movers, or any other device or method capable of moving air. In preferred embodiments, a circulation fan 71 may be mounted on an interior surface (facing the front cover 10) of the rear panel 20, and an air vent 72 may be mounted on an exterior surface (facing away from the front cover 10) of the rear panel 20. The air vent 72 may be configured to enable air to pass through the rear panel 20 to the circulation fan 71 preferably while being configured to limit the passage of dirt, rain, pests, and other contaminants from passing through the air vent 72.

In some embodiments, the device 100 may comprise a wall bracket 40. Preferably, a wall bracket 40 may be used to coupled the rear panel 20 to a wall or other generally flat or planar surface. In preferred embodiments, a wall bracket 40 may comprise one or more center standoffs 42, rear uprights 44, and front uprights 46. In further embodiments, a wall bracket 40 may comprise a front upright 46 coupled to a rear upright 44 via a center standoff 42. A center standoff 42 may comprise a horizontally oriented plate. A rear upright 44 may comprise a generally vertically oriented plate extending approximately perpendicularly upwards from the rear of the center standoff 42. A front upright 46 may comprise a generally vertically oriented plate extending approximately perpendicularly downwards from the front of the center standoff 42. Preferably, a center standoff 42 and/or a front upright 46 may comprise a cutout 48 for one or more cables to pass through or around the wall bracket 40. In preferred embodiments, a rear upright 44 may be coupled to a wall or other generally flat surface at two or more points provided by two or more bracket apertures 49 for wind load resistance and the front upright 46 may coupled to the rear panel 20 or vice versa.

In some embodiments, the device 100 may comprise one or more pole mounts 60. The pole mount 60 may be configured to couple the rear panel 20 of the device 100 to a pole or other rounded or curved surface. A pole mount 60 may comprise a spine 62 to which one or more legs 64 and one or more arms 66 may be coupled to. The spine 62 may be a vertically oriented plate or any other structure of any size and shape. The spine 62 may comprise one or more spine apertures 68 for ventilation and/or cables to pass through.

Legs 64 may be configured in any size and shape. In some embodiments, a leg 64 may extend generally perpendicularly towards the rear panel 20 and extend generally perpendicularly away from the spine 62 of the pole mount 60. Optionally, one or more legs 64 may extend from the spine 62 towards and into contact with the rear panel 20 so that the one or more legs 64 may be coupled to the rear panel 20, such as with one or more fasteners that may be inserted through a pole aperture 69 of a leg 64 and into a rear aperture 22 of a rear panel 20, although any other coupling method may be used.

Arms 66 may be configured in any size and shape. In some embodiments, an arm 66 may extend from the spine 62 while being angled relative to the spine 62, such as in an oblique angle relative to the spine 62. Each arm 66 may comprise an arm surface 67 which may be placed in contact with and coupled to a pole or other rounded or curved surface, such as with one or more fasteners that may be inserted through a pole aperture 69 of an arm 66 and into the pole or other rounded or curved surface, although any other coupling method may be used.

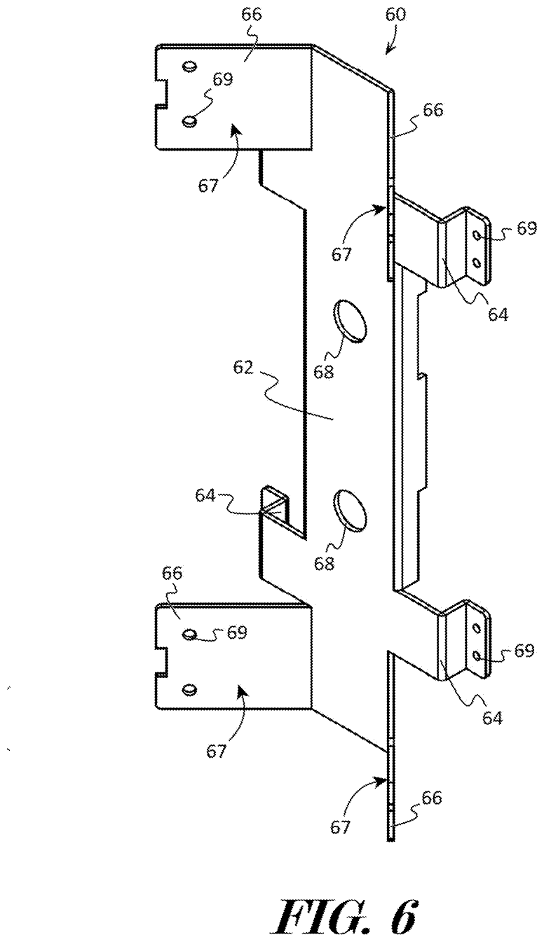

In preferred embodiments, a pole mount 60 may comprise two arms 66, each having an arm surface 67, which may be coupled to opposing sides of the spine 62, and each arm surface 67 may be positioned above the spine 62. In further preferred embodiments, the arm surfaces 67 of the two opposingly coupled arms 66 may be angled relative to each other, such as between approximately 30 and 179 degrees as shown by Angle A in FIG. 4. In still further embodiments, one or more arms 66 may be coupled to the spine 62 so that the arms 66 are positioned above the spine 62 (relative to the legs 64), and one or more legs 64 may be may be coupled to the spine 62 so that the legs 64 are positioned below the spine 62 (relative to the arms 66) as shown in FIG. 6.

While some exemplary shapes and sizes have been provided for elements of the device 100, it should be understood to one of ordinary skill in the art that the front cover 10, rear panel 20, top plate 30, wall bracket 40, pole mount 60, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A camera enclosure device, the device comprising:
a front cover having a curved front plate, the curved front plate coupled between a left side plate and a right side plate;
a top plate coupled to an upper end of the front cover, the top plate extending to contact the curved front plate, the left side plate, and the right side plate;
a lens aperture disposed in the front cover; and
a rear panel coupled to a bottom plate, the bottom plate extending to contact the curved front plate, the left side plate, and the right side plate at a lower end of the front cover when the rear panel is coupled to the front cover.

2. The device of claim 1, further comprising a mounting plate coupled to the rear panel.

3. The device of claim 1, wherein the top plate comprises a cable aperture.

4. The device of claim 1, wherein a lens is coupled to the lens aperture.

5. The device of claim 4, wherein the lens is coupled to the curved front plate, the left side plate, and the right side plate.

6. The device of claim 1, further comprising a circulation fan.

7. The device of claim 1, further comprising a pole mount.

8. The device of claim 1, wherein the pole mount comprises two arms coupled to a spine, wherein each arm comprises an arm surface, and wherein each arm surface is positioned above the spine.

9. The device of claim 8, wherein the pole mount comprises two legs coupled to the spine, and wherein each leg is positioned below the spine.

10. The device of claim 1, further comprising a wall bracket.

11. The device of claim 10, wherein the wall bracket comprises a front upright coupled to a rear upright via a center standoff.

12. A camera enclosure device, the device comprising:
a front cover having a curved front plate, the curved front plate coupled between a left side plate and a right side plate;
a top plate coupled to an upper end of the front cover, the top plate extending to contact the curved front plate, the left side plate, and the right side plate;
a lens aperture disposed in the front cover, the lens aperture extending from the left side plate to the right side plate;
a lens coupled to the lens aperture, wherein the lens is coupled to the curved front plate, the left side plate, and the right side plate; and
a rear panel coupled to a bottom plate, the bottom plate extending to contact the curved front plate, the left side plate, and the right side plate at a lower end of the front cover when the rear panel is coupled to the front cover.

13. The device of claim 12, further comprising a mounting plate coupled to the rear panel.

14. The device of claim 12, wherein the top plate comprises a cable aperture.

15. The device of claim 12, further comprising a circulation fan.

16. The device of claim 12, further comprising a pole mount.

17. The device of claim 16, wherein the pole mount comprises two arms coupled to a spine, wherein each arm comprises an arm surface, and wherein each arm surface is positioned above the spine.

18. The device of claim 17, wherein the pole mount comprises two legs coupled to the spine, and wherein each leg is positioned below the spine.

19. The device of claim 12, further comprising a wall bracket.

20. The device of claim 19, wherein the wall bracket comprises a front upright coupled to a rear upright via a center standoff.
